(19) United States
(12) Patent Application Publication
(10) Pub. No.: US 2004/0080514 A1
(43) Pub. Date: Apr. 29, 2004

(54) System and method for automated data extraction, manipulation and charting

(76) Inventor: Richard Wilson Dorwart, San Francisco, CA (US)

Correspondence Address: Bradley J. Bereznak, Burgess & Bereznak LLP, Suite 180, 800 El Camino Real, Mountain View, CA, 94040, US

(21) Appl. No.: 10/279,620

(22) Filed: Oct. 24, 2002

(51) Int. Cl. G09G 5/00

(52) U.S. Cl. 345/581

(57) ABSTRACT

A system and method for automated data extraction, manipulation, and charting is disclosed. Specified data is extracted from a spreadsheet and then automatically transformed using a software algorithm into one or more graphical presentations, such as charts and/or tables. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

The present invention relates generally to information management, more particularly, to systems and methods for generating data charts and/or graphs using information extracted from data tables in a spreadsheet.

### BACKGROUND

Research and analysis of raw data is important in a wide variety of fields, and typically involves traversing isolated information sources including paper reports and internal databases such as the Microsoft Excel™ spreadsheet to extract and analyze data in business, government, and academic settings. By way of example, each chart or slide in a PowerPoint™ presentation is prepared individually by extracting data by hand from an Excel™ spreadsheet format and by entering the data manually into the presentation program.

Even in the computer age, the task of generating data charts and the like from data sources is often tedious and requires a significant amount of time. One might conclude that today's information worker is much like the previous generation's factory worker assembling parts alongside a conveyer belt. The task is no longer to refine an endless stream of raw materials into physical goods, but rather to refine an ever-increasing amount of raw data into an understandable form.

An example of such ‘industrialized’ information work is the custom or ‘ad hoc’ market research (“MR”) industry. The MR industry serves virtually all of the nation's major companies from consumer packaged goods to industrial products to services of every type. Market research vendors provide technical research design, implementation, and analytical services for their clients.

Market researchers typically tabulate raw data, such as data regarding consumer responses to various questions about a particular product and/or service, into books of data tables that researchers can refer to when they conduct their analysis. The information in the data tables is then presented in a user-friendly format, such as in charts and/or graphs created using an application like PowerPoint™, so that the results can be easily understood by clients. Putting the data into this user-friendly format is usually the job of the market researcher. For instance, the charting task often entails physically paging through a book or electronic version of data tables that can be thousands of pages long, selecting the needed data, and then manually typing or pasting the data into dozens if not hundreds of individual PowerPoint™ charts. It is not uncommon for this part of a market research job to take a researcher about 50 man-hours to complete.

What is needed is a system and method for expediting the process of finding and extracting specified data from data tables and for changing that data into an understandable, comprehensive form.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a flow chart illustrating the steps of a prior art process.

FIG. 2 is a flow chart illustrating the market research process according to one embodiment of the present invention.

FIG. 3 is a flow chart that shows the steps of creating a graphical presentation using tabulated data extracted from a spreadsheet according to one embodiment of the present invention.

FIG. 4A is an example of tabulated data stored in a spreadsheet according to one embodiment of the present invention.

FIG. 4B shows portions of the tabulated data from FIG. 4A transformed into a graphical presentation of one attribute according to one embodiment of the present invention.

FIG. 4C shows portions of the tabulated data from FIG. 4A transformed into a graphical presentation showing another attribute according to one embodiment of the present invention.

FIG. 4D shows portions of the tabulated data from FIG. 4A transformed into a graphical presentation of yet another attribute according to one embodiment of the present invention.

FIG. 5 is a user interface for transforming data into a graphical presentation according to one embodiment of the present invention.

FIG. 6 illustrates a computer system for implementing the method of the present invention.

### DETAILED DESCRIPTION

A system and method for data extraction and charting is described. In the following description numerous specific details are set forth, such as particular computer programs, an example use of the invention in the market research field, and details regarding particular types of tabulated data, in order to provide a thorough understanding of the present invention. However, persons having ordinary skill in the information management arts will appreciate that these specific details may not be needed to practice the present invention.

According to an embodiment of the present invention, object linking and embedding technology (“OLE”), such as Microsoft's OLE Automation Technology, is used to program various applications. The applications may include Microsoft Excel™, PowerPoint™, SPSS™, or any other types of commercially available software packages that support automation. The invention automatically extracts specific figures from one or more data tables and then inserts these figures into a presentation. The presentation may be a graphical, tabular, and/or chart representation of the data tables. A set of business rules and processes is implemented using an algorithm according to one embodiment of the present invention. Execution of the algorithm causes specific data to be electronically identified and extracted from one computer program, such as Microsoft Excel™, and inserted and transformed into another program, such as PowerPoint™, thereby automating an information extraction and charting process that has traditionally been tedious and time-consuming.

In one embodiment, the system and method of data extraction and charting is used in the market research industry to efficiently transform large amounts of data located in data tables into a user-friendly format so that the data can be readily analyzed and interpreted. Of course, it should be understood that the present invention may be used in any application where it would be useful to efficiently transform large amounts of data into a graphical and/or chart form. Thus, the present invention has utility in fields such as academic research, investment banking, medical research, and so on.

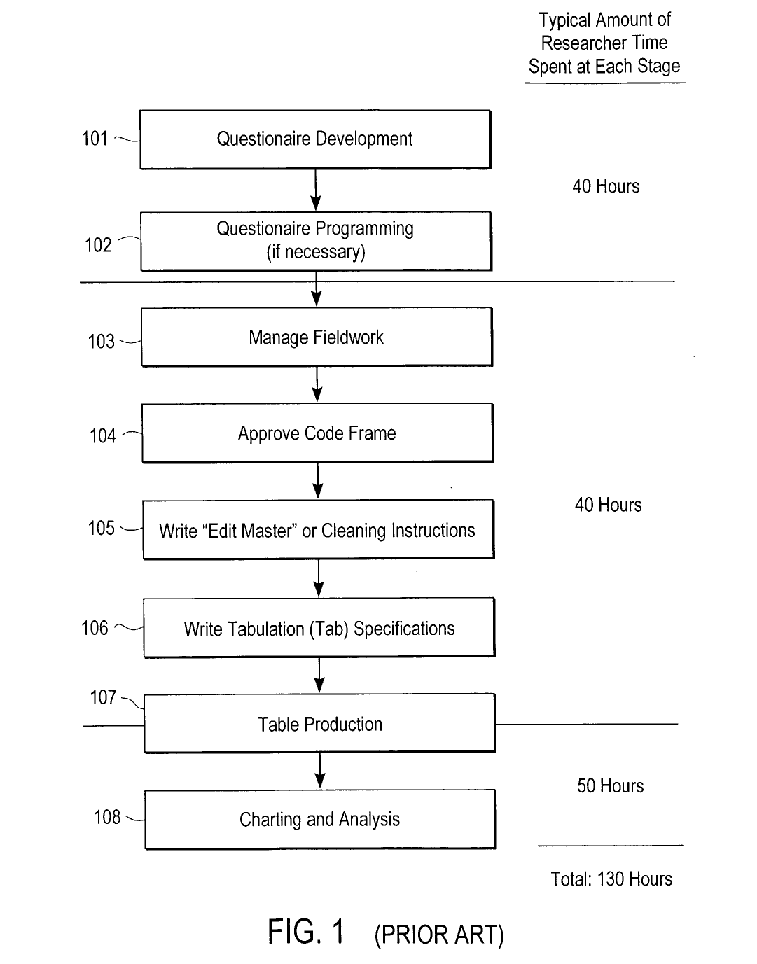

Referring now to FIG. 1 there is shown a flow chart illustrating the steps of an exemplary prior art process for conducting market research. FIG. 1 summarizes the market research process from the point of view of a research staff person, such as a project manager or analyst. The sequence of steps shown in FIG. 1 are for customized quantitative projects that involve hundreds or perhaps thousands of interviews. In essence, FIG. 1 shows a complete project cycle from beginning to end. It is important to note that, in practice, every project is different and may incorporate some or all of these steps as appropriate.

First, the scope and nature of the research is defined. The research definition process typically involves creating a questionnaire (block 101) designed to answer specific questions such as product usage frequency, brand awareness, customer satisfaction, brand image, concept and/or product acceptability, etc. Next, questionnaire programming (block 102) is implemented. Questionnaire programming typically involves managing and testing outsourced programming of electronic questionnaires for on-line or computer assisted interviewing, although sometimes questions are still implemented using a manual ‘pencil and paper’ method.

The first two steps of this process (blocks 101 and 102) usually take about 40-50 hours for an individual market researcher to complete. At the next step, fieldwork is conducted (block 103). This fieldwork usually includes hiring a data collection company to interview consumers and/or potential consumers, monitoring interviews, conducting field briefings, managing incentive payout, etc. The fieldwork potentially involves sampling hundreds, if not thousands, of consumers and/or potential consumers. Once the fieldwork is completed or partially completed a number of the next steps take place in rapid succession and in some cases simultaneously. For example, responses from any open-ended questions (e.g., “What did you like about the advertisement you saw?”) need to be fit into a master code frame (block 104). During this process, open-ended question responses are transformed into a single sentence that catches the meaning of the response. For example, if some people say they like the color of the product, and other people said they like the fact that the product is blue, these responses would simply be transformed into a single code that says “color”. Then, the open-and closed-ended data are aggregated and cleaned (block 105) to ensure the integrity of the data tables, for instance, to ensure that there are no blank responses and that questions were asked of the correct respondents. Concurrently, the tabulation specifications and programming are developed (block 106), which includes specifying data table banner points and stubs, as well as creating the table bases and general layout. When both the tabulation specifications and program have been written and the data coded, aggregated and cleaned, then data tables are produced (block 107) that organize the data collected from the completed field work. Frequently, tab programming is outsourced to a data-processing house that uses an industrial tabulation software package like Quantum™ or Uncle™. The steps in this process (blocks 103-107) may take a typical market researcher 40 hours to complete. Finally, the data in the tables is charted and analyzed (block 108). That is, the data is manually entered from the data tables into a program such as PowerPoint™ and then transformed into presentation quality graphics that illustrate the analysis of the data.

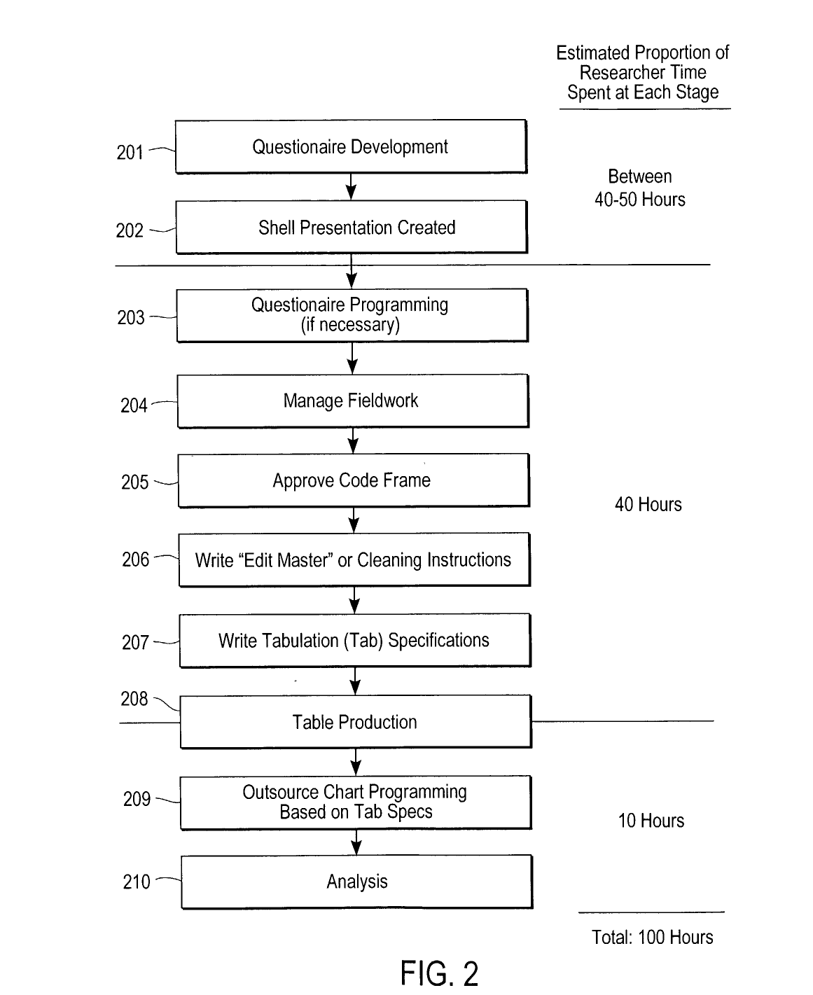

Referring now to FIG. 2 there is shown a flow chart illustrating the market research process according to one embodiment of the present invention. First, a questionnaire is developed (block 201). A shell presentation to be populated by data is created (block 202). This step is only necessary if a shell presentation or a prior graphical presentation has not already been implemented. Next, questionnaire programming (block 203) is implemented, field work is conducted (block 204), and data is fit into a master code frame (block 205). In the next steps, the data is cleaned (block 206) and data tables are created (block 207). The creation of the data tables (block 207) may be outsourced and run on an industrial tab package such as Quantum™ (as is shown in FIG. 2) or may be automated according to another embodiment of this invention. That is, the data tables may be created according to an algorithm which uses a desktop application, such as SPSS, to automate the tabulations, run them, and then export the data tables back to a program such as Excel. A desktop programming language, for example, SPSS syntax, Visual Basic, or other types of computer programming languages may be used to write an algorithm to allow a user to record the types of data tables that are being created. Once the user has recorded this information, when the user gets a new data set, the user can create the same data tables out of raw data by simply running the code. Once the data tables are created, the data in the data tables is automatically transformed into a graphical presentation by outsourcing chart programming based on the tabulation specifications (in practice, chart automation may be programmed based on tabulation specifications, an interim tabulation itself or both) (block 208). In this manner, the graphical presentations are produced (block 209). The outsourcing involves an implementation of the invention. That is, a consultant may be employed by the market researcher to implement an algorithm that automatically transforms specified tabulated data in the data tables into graphical presentations. Alternatively, the market researcher could use a software package including a user-interface to automatically transform the tabulated data in the data tables into graphical presentations (not shown in this view). In this case, the charting would not be outsourced, but would be conducted by the market researcher. The algorithm used to create the graphical presentations will be described in more detail herein. The charts may then be analyzed by one or more market researchers (block 210). In this manner, rather than spending 50 hours on charting and analysis, a market researcher can typically create effective graphical presentations to illustrate his/her analyses in under 10 hours.

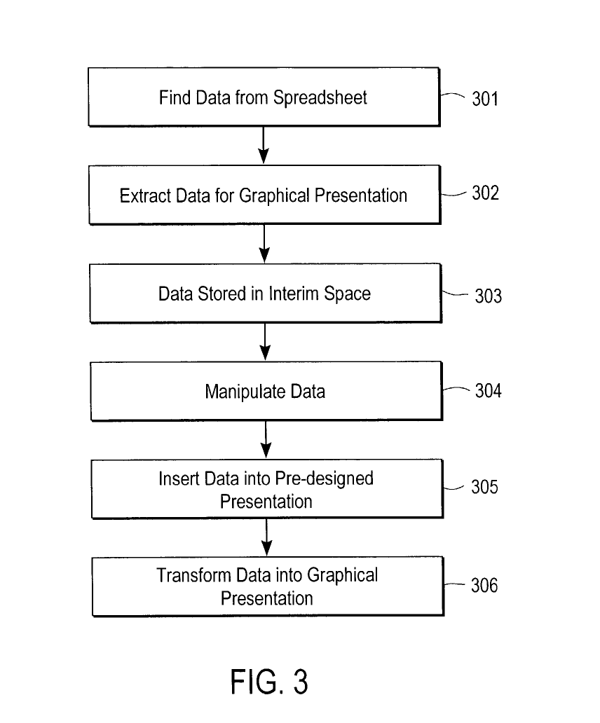

Referring now to FIG. 3 there is shown a flow chart that shows the steps of creating a graphical presentation from tabulated data in a spreadsheet according to one embodiment of the present invention. The steps may be implemented according to an algorithm written in software such as Java, Visual Basic, C++, or other types of programming languages that can be stored in a computer readable medium.

The first step of the program identifies data for the particular question of interest from the tabulated data in the spreadsheet (block 301). For example, questionnaire respondents may be asked what their purchase intention is for a particular product, and may be asked to choose between the responses of “very likely to buy,” “neither likely nor unlikely to buy,” or “very unlikely to buy.” At the first step (block 301) the program finds the response to the question regarding purchase intention from the tabulated data in the spreadsheet (not shown in this view).

In the second step the program extracts the precise data from the tabulated data that is needed for a chart and/or graphical presentation to be created (block 302). A chart may be created, for example, that demonstrates or illustrates how many respondents are “very likely” to purchase a particular product after having seen that product. In this instance, the data that is extracted from the tabulated data indicates the number of people, (in this example 35 people), from a particular sample group of people polled, (e.g., 100 people), who are “very likely” to purchase the product (not shown in this view).

Once the proper data is extracted, it is stored in an interim space (block 303). For example, the data may be stored in another spreadsheet in Excel™ in the tabulated data file. Of course, the data may be stored in other locations on the computer (not shown in this view) as well. Next, the storage program may manipulate the data in order to shape it as required to create a specified chart, graph, or table in the graphical presentation (block 304). Finally, object linking and embedding (“OLE”) technology or another technology that performs a similar function is used to automatically insert the stored data into a presentation format (block 305). In one embodiment of the present invention, Microsoft's OLE Automation Technology is used, but other OLE technologies may be used as well. In this manner, the extracted data is automatically transformed into an easy-to-read graphical presentation (block 306) that displays the data in a coherent, understandable, summary form.

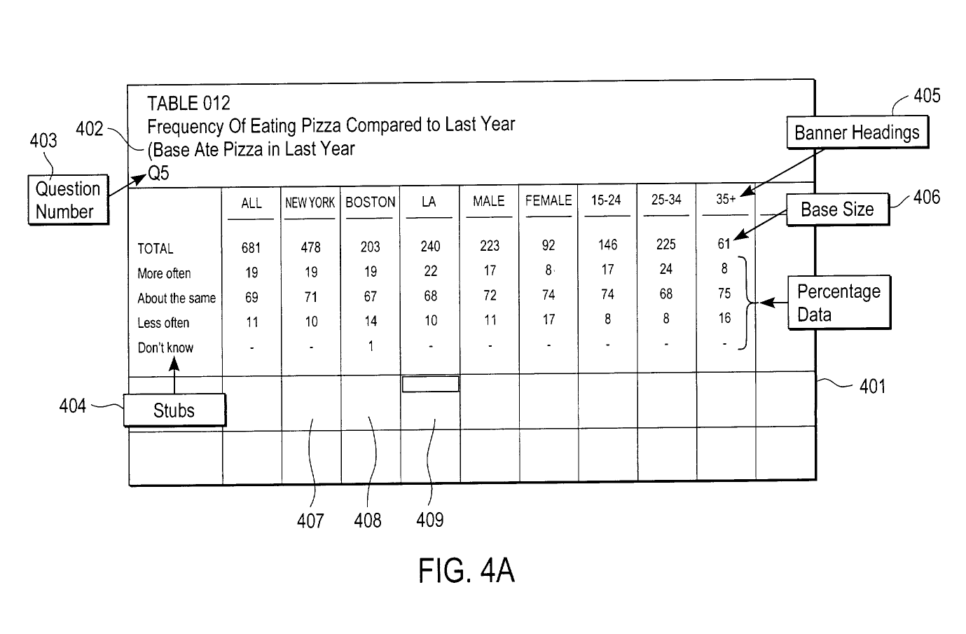

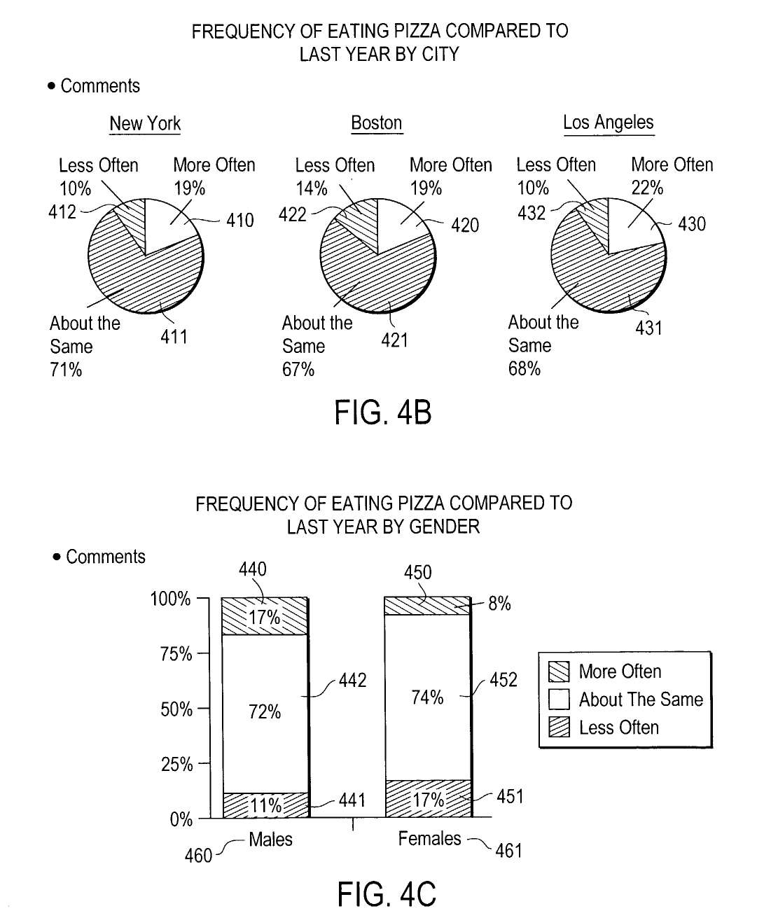

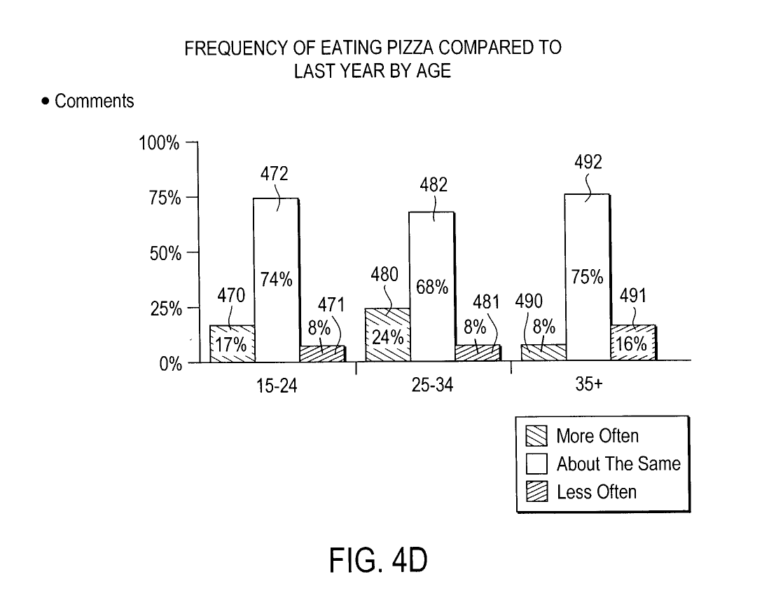

Turning now to FIG. 4A there is shown an example of tabulated data stored in a spreadsheet according to one embodiment of the present invention. In the example illustrated by FIG. 4A, the sample tabulated data 401 is located in a spreadsheet in Excel™, but as noted herein, the data may be located in numerous other programs as well. The data in FIG. 4A was gathered from a questionnaire that included a question about the annual frequency of people's pizza eating habits for given segments of the population. The base sample 402 only includes people who actually ate pizza in the last year. The sample tabulated data 401 demonstrates the response to question number five (“Q5”) 403 in the survey. The stubs 404 include the following response selections: “More Often,” “About the Same,” “Less Often,” and “Don't know.” The banner headings 405 designate the population surveyed segmented by the geographic locations of New York, Boston, and Los Angeles, by gender, and by the age groups 15-24, 25-34, and 35+. The banner headings 405 also include a heading for “All”, which represents the total population that was asked this question in the survey and responded. The base size 406 for each group of respondents is located directly under the base headings 405. The percentage data 406 is displayed in columns 407, 408, 409, etc., below the base size 406 for each population segment.

FIG. 4B shows portions of the tabulated data from FIG. 4A transformed into a graphical presentation of one attribute according to one embodiment of the present invention. Although the particular data from FIG. 4A only populates three charts in PowerPoint™ (FIGS. 4B-4D), it should be noted that programs may be written to extract precise data from tabulated data in a spreadsheet and to automatically insert the data into hundreds or even thousands of charts in a presentation. In this manner, tabulated data is electronically transformed into graphical presentations. These presentations may be updates of an existing presentation from a previous study or entirely new sets of charts developed in tandem with a given questionnaire. FIG. 4B represents a PowerPoint™ presentation updated with figures from the final tabulated data of FIG. 4A illustrating the responses to the question about frequency of pizza eating segmented by the geographic regions of New York, Boston, and Los Angeles. The percentage data is shown in chart form, with the response “more often” 410, 420, and 430, the response “about the same” 411, 421, and 431, and the responses “less often” 412, 422, and 432, clearly illustrated for each city. In this manner, the graphs effectively illustrate the percentage responses in a readily understood format. In addition, it should be noted that the data may be manipulated (ranked, sorted, transposed, etc.) as necessary to facilitate the chart making process. This manipulation may be conducted in the interim storage space.

Referring now to FIG. 4C there is shown portions of the tabulated data from FIG. 4A transformed into a graphical presentation showing another attribute according to one embodiment of the present invention. The percentage data is shown in chart form, with the response “more often” 440 and 450, “less often” 441 and 451, and “about the same” 442 and 452, clearly delineated for males 460 and females 461.

Turning now to FIG. 4D there is shown portions of the tabulated data from FIG. 4A transformed into a graphical presentation of yet another attribute according to one embodiment of the present invention. In this chart, the percentage data is displayed according to the age groups 15-24, 25-34, and 35+. The responses “more often” 470, 480, and 490, “less often” 471, 481, and 492, and ‘about the same” 472, 482, and 492 are clearly displayed.

Of course, it should be noted that a wide variety of charts may be created representing in graphical form a variety of data using the present invention. For example, questionnaires regarding customer satisfaction may be implemented (not shown in this view), with charts created showing overall satisfaction scores by population segment, the drivers of satisfaction, and so forth.

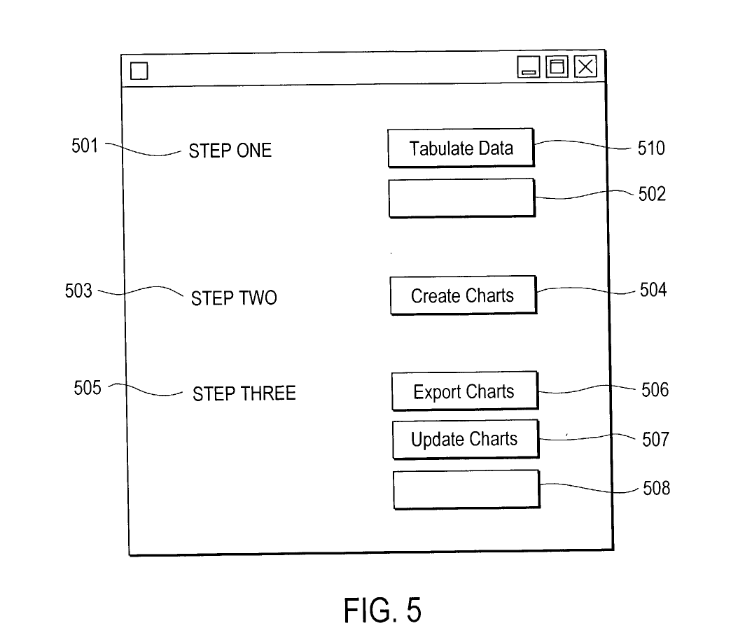

Another embodiment of the present invention provides for a user interface for transforming data into a graphical presentation which is illustrated by FIG. 5. According to this embodiment of the present invention, software code for implementing the steps of extracting specified tabulated data from a spreadsheet and for transforming the data into a graphical presentation is compiled into a visual tool. At step one 501 on the user interface, a user is asked to tabulate data by entering the name of a data file the user wants to run in box 502 and then by clicking on a box entitled “Tabulate Data” 510. At step two 503, a user clicks on the box entitled “Create Charts” 504. At step three 505, the user exports charts or data to a program to implement graphical presentations. For example, the user can click on the box entitled “Export Charts” 506 to export Excel™ charts to a new PowerPoint™ file or the user can click on the box entitled “Update Charts” 507 to update existing PowerPoint™ Charts. If box 507 is selected, the user is asked to specify the name of the PowerPoint™ file the user wants updated in box 508. Either way, a graphical presentation is electronically created using the visual tool of FIG. 5.

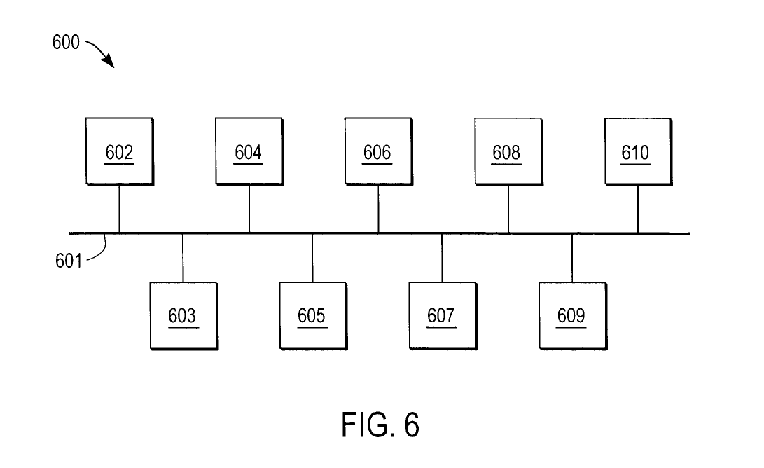

FIG. 6 illustrates a computer system for implementing the method of the present invention. The computer system 600 includes a processor 602 that executes a program that includes instructions that cause the algorithm to perform the steps of the invention. The processor 602 is coupled through a bus 601 to a random access memory (RAM) 603, a read only memory (ROM) 604, and a mass storage device 605. The ROM 604 may store the program to execute the steps of the invention. The RAM 603 may be used as an interim storage space for the specific tabulated data that is extracted from a spreadsheet, for example. Mass storage device 605 could be a disk or tape drive for storing data and instructions. A display device 606 for providing visual output is also coupled to processor 602 through bus 601. A user interface (not shown in this view) may be displayed on the display device 606. Keyboard 607 is coupled to bus 601 for communicating information and command selections to processor 602. Another type of user input device is cursor control unit 608, which may be a device such as a mouse or trackball, for communicating direction commands that control cursor movement on display 609. For example, the cursor control until 608 may be used to click on a box (not shown in this view) that will transform the tabulated data into graphical presentations. Further coupled to processor 602 through bus 601 is an input/output (I/O) interface 610 which can be used to control and transfer data to electronic devices connected to computer 600, such as other computers, tape records, and the like.

Network interface device 610 is coupled to bus 601 and provides a physical and logical connection between computer system 600 and a network medium, such as the Internet (not shown in this view). Depending on the network environment in which computer 600 is used, this connection is typically to a server computer, but it can also be to a network router to another client computer. Note that the architecture of FIG. 6 is provided only for purposes of illustration, and that a client computer used in conjunction with the present invention is not limited to this specific architecture.

In the foregoing, a system and method has been described for automated data extraction, manipulation, and charting. Although the present invention has been described with reference to specific exemplary embodiments, it should be understood that numerous changes in the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

I claim:

1. A computer-implemented method for data management, comprising:
extracting data having one or more attributes from a data table of a first computer program;
inserting the data into a storage location where it can be used by or inserted into a second computer program; and
transforming the data into a graphical presentation using the second computer program.

2. The method of claim 1 further comprising storing the data in an interim space prior to inserting the data into the second program.

3. The method of claim 2 wherein the interim space comprises a spreadsheet data table.

4. The method of claim 1 wherein extracting the data from the first computer program and inserting the data into the second computer program is performed by an object linking and embedding technology.

5. The method of claim 1 further comprising automating the creation of the data tables by a third computer program.

6. The method of claim 5 wherein the third computer program exports the data table to the first computer program.

7. A computer program product, comprising:
a computer useable medium and computer readable code embodied on the computer useable medium to identify data having one or more attributes located in a tabular form in a spreadsheet program, extract the data, insert the data into a graphical program, and transform the data into a graphical presentation.

8. The computer program product of claim 7 wherein the data is stored in an interim space on the computer useable medium prior to inserting the data into the graphical presentation.

9. The computer program of claim 7 wherein the interim space is a spreadsheet data table.

10. The computer program of claim 7 wherein object linking and embedding technology is used to insert the data into the graphical presentation.

11. The computer program of claim 7 wherein the data is transformed into the tabular form by the computer readable code.

12. A method of analyzing tabulated data located in a spreadsheet program, comprising:
providing a first algorithm to automatically transform data into tabulated data located in a spreadsheet program;
providing a second algorithm to automatically find designated tabulated data located in the spreadsheet program;
inserting the designated data into a graphical presentation program using object linking and embedding (“OLE”) technology; and
generating a graphical presentation representative of the designated data.

13. The method of claim 12 wherein the designated tabulated data is located in the spreadsheet on a first computer program.

14. The method of claim 13 wherein the first computer program comprises Excel™.

15. The method of claim 12 wherein the graphical presentation is located in a second computer program.

16. The method of claim 15 wherein the second computer program comprises PowerPoint™.

17. The method of claim 12 further comprising storing the designated tabulated data in an interim space before the data is inserted in the graphical presentation.

18. The method of claim 17 wherein the interim space is an Excel™ spreadsheet.

19. The method of claim 12 further comprising providing a user interface for transforming the designated tabulated data into the graphical presentation.

20. The method of claim 19 wherein the user interface includes a space to enter the name of the data file a user wants to analyze, manipulate, and chart.

21. The method of claim 20 wherein the user interface includes a space for a user to specify where the extracted data should be sent in a graphical presentation.

22. The method of claim 21 wherein the user interface includes a box for a user to click on to update existing graphical presentations with the designated tabulated data.

23. The method of claim 12 further comprising manipulating the data before inserting the designated data into the graphical presentation.

24. A data management system, comprising:
a first algorithm for extracting data having one or more attributes from a data table located on a first computer program;
a second algorithm for inserting the data into a storage location where it can be used by or inserted into a second computer program; and
a third algorithm for transforming the data into a graphical presentation using the second computer program.

25. The data management system of claim 24 wherein the storage location is a spreadsheet data table.

26. The data management system of claim 24 wherein an object linking and embedding technology is used to transform the data from the first computer program into the graphical presentation on the second computer program.

27. The data management system of claim 1 wherein a fourth algorithm is used to automate the creation of data tables from raw data located on a third computer program.
